(19) United States
(12) Patent Application Publication
(10) Pub. No.: US 2013/0138342 A1
(43) Pub. Date: May 30, 2013

(54) METHOD AND APPARATUS FOR INDOOR NAVIGATION

(71) Applicants: Jacob ZAID, Haifa (IL); Shalom DASKAL, Ramat Efal (IL)

(72) Inventors: Jacob ZAID, Haifa (IL); Shalom DASKAL, Ramat Efal (IL)

(21) Appl. No.: 13/664,024

(22) Filed: Oct. 30, 2012

Related U.S. Application Data
(60) Provisional application No. 61/564,352, filed on Nov. 29, 2011.

(51) Int. Cl. G01C 21/00

(52) U.S. Cl. 701/526; 701/408

(57) ABSTRACT

A device and method for assisting navigation to an indoor stationary object within a building, comprising: a user interface module for receiving an indication of the current location of a user and of an indoor stationary object within a building, and for presenting the direction of an indoor stationary object to the user; a storage device for storing Absolute Locations of the current location and the indoor stationary object; an instruction generation component for determining distance and navigation instructions between the current location and the indoor stationary object; a direction determination unit for determining a direction a user holding the device is moving at; a distance evaluation unit for determining a distance passed by a user holding the device; and a user updated location determination component for evaluating a current location of a user holding the device based on information received from the direction determination unit and distance evaluation unit.

### FIELD OF THE INVENTION

The present invention relates to an apparatus and method for navigating within buildings, and in particular navigating towards indoor stationary objects within the building.

### BACKGROUND OF THE INVENTION

Emergency services are often required to find their way within an unknown indoor environment, such as a large building. In some cases, for example when the building is on fire, visibility may be limited, which makes such navigation even harder.

The emergency forces may find it advantageous to have valid information about important indoor stationary objects and their related location within a building, such as a fire hydrant, a fuse box, a communication center, a stairwell, an elevator shaft, a safe, a fire resistant door, an emergency exit, a crash bar, a panic hardware, high-hazard items, safeguards, an emergency alarm system, an emergency light system, a fire detection system, an emergency tool or others.

However, a floor plan of the building is generally insufficient for such navigation for a number of reasons.

First, the plan may not indicate all the required stationary objects. Some stationary objects added after the plan was created may not be indicated on the plan, and other stationary objects may be dispersed between a number of plans, such as construction plan, electricity plan, or the like.

Further, a floor plan may indicate internal walls as existed when the plan was created. However, internal walls are subject to removal, addition, or other changes without providing notice to authorities, thus rendering the plan invalid. For example, relying that a certain corridor leads to a required stationary object such as a fire hydrant, only to find out that the corridor has been blocked, may waste expensive time. Thus, a plan with incorrect internal walls indications may cause more harm than not supplying internal wall information at all.

Another option relates to providing the exact coordinates of the required stationary object location. However, Global Positioning System (GPS) devices which may make use of such information are generally useless indoors in areas which are not immediately adjacent to an opening such as a window, because the device cannot communicate with satellites.

There is thus a need for a method and apparatus for navigating within buildings, and in particular to the exact location of indoor stationary objects within the building.

### SUMMARY OF THE INVENTION

One aspect of the disclosure relates to a device for assisting a user to navigate to a stationary object within a building, comprising: a user interface module for receiving an indication of a current location of a user and of a stationary object within a building, and for presenting navigation instructions to the user; a storage device for storing absolute locations of the current location and the stationary object; an instruction generation component for determining distance and navigation instructions between the current location and the stationary object; a direction determination unit for determining a direction a user holding the device is moving at; a distance evaluation unit for determining a distance passed by a user holding the device; and a user updated location determination component for evaluating a current location of a user holding the device, based on information received from the direction determination unit and distance evaluation unit. In some embodiments, the direction determination component may comprise a compass. In some embodiments, the direction determination component may comprise a gyroscope. In some embodiments, the distance evaluation component may comprise a pedometer. In some embodiments, the device may further comprise an altimeter for determining the height at which the device is located.

Another aspect of the disclosure relates to a method for assisting a user to navigate to a stationary object within a building, comprising: receiving a destination indication of a stationary object within a building; receiving a start location indication within the building; retrieving absolute location of the current location and the stationary object; determining navigation instructions between the current location and the stationary object; and presenting the navigation instructions to the user. In some embodiments, the method may further comprise: receiving one or more indications to distance or direction walked by the user; determining an updated location of the user based on the indications; and updating the navigation instructions based on the updated location. In some embodiments, the method may further comprise a calibration step for associating a user's step with a length. In some embodiments, the method may further comprise: receiving an indication to a height; and loading information related to stationary objects located at the height.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows a schematic illustration of a person using a navigation device in accordance with the disclosure, entering into a building;

FIG. 2 shows an exemplary sequence steps when navigating within a building, and associated screen shots associated with the steps;

FIG. 3 is a flowchart of steps in a method for navigating within a building, in accordance with some exemplary embodiments of the invention; and

FIG. 4 is a schematic block diagram of a device for navigating within a building towards an indoor stationary object, in accordance with some exemplary embodiments of the invention.

### DETAILED DESCRIPTION

The following description relates to navigating within a building towards a stationary object.

One technical problem handled by the disclosed method and apparatus relates to the need to navigate within a building, for example to a stationary object such as a fire hydrant, a fuse box, a stairwell, an elevator or elevator shaft, an emergency exit, a crash bar, a panic hardware, high-hazard items, safeguards, an emergency alarm system, an emergency light system, a fire detection system, an emergency tool or the like. The stationary object may not be immediately seen to a person entering the building since it may be located further inside, and in particular in situations in which visibility is limited, for example in cases of darkness, smoke, fire, or the like.

Even when the absolute locations of the stationary objects are known and available, it may not help people such as emergency personnel to navigate to a stationary object since global positioning system (GPS) devices cannot be used within the building.

One technical solution which will enable the identification of the absolute location of stationary objects is the usage of the relative location information. The absolute coordinates of the stationary objects, as including locations such as possible entry points to the building or to a floor within the building are available and stored on a device used by the personnel, such as a handheld device.

Upon entry to the building, the user may select the building and the entry point using the device, for example “White building” and “Main Entrance”. Each selection may be made from a pre-defined list. The person may then indicate the stationary object he or she wants to navigate to, by selecting from a predefined list of stationary objects for which location information is available.

The device then determines the distance and direction between the current location of the user and the targeted stationary object, and provides the user with related navigation instructions or directions.

The directions may be presented to the user on a map indicating the current location and the destination and optionally the direction to take and the distance, in textual mode, for example “advance 30 yards to the north”, or in a combination thereof.

The device may be equipped with a distance evaluation unit such as a pedometer, and with a direction determination unit such as a compass and/or a gyroscope, which may be used estimate the updated location of the user and update the navigation directions accordingly.

The directions may also be updated when the reports that he arrived at another stationary object for which location information is available, such as a stationary object or another entry point. The user may thus set the current location by selecting it from the list, and receive updated instructions.

It will be appreciated that when the user arrives at a staircase, the device can count the stairs the user is climbing, determine which floor the user arrived at, and load the relevant available locations for that floor. Alternatively, the device can determine the height or the floor using an altimeter.

One technical effect of the disclosed subject matter is providing a method and apparatus for navigating to stationary objects within a building, and in particular in situations where visibility is limited.

The method and apparatus do not rely on any existing knowledge referring to internal walls of the building, but only to data related to stationary objects which are generally static.

The apparatus is portable and easy to use, in order to save precious time in emergency situations.

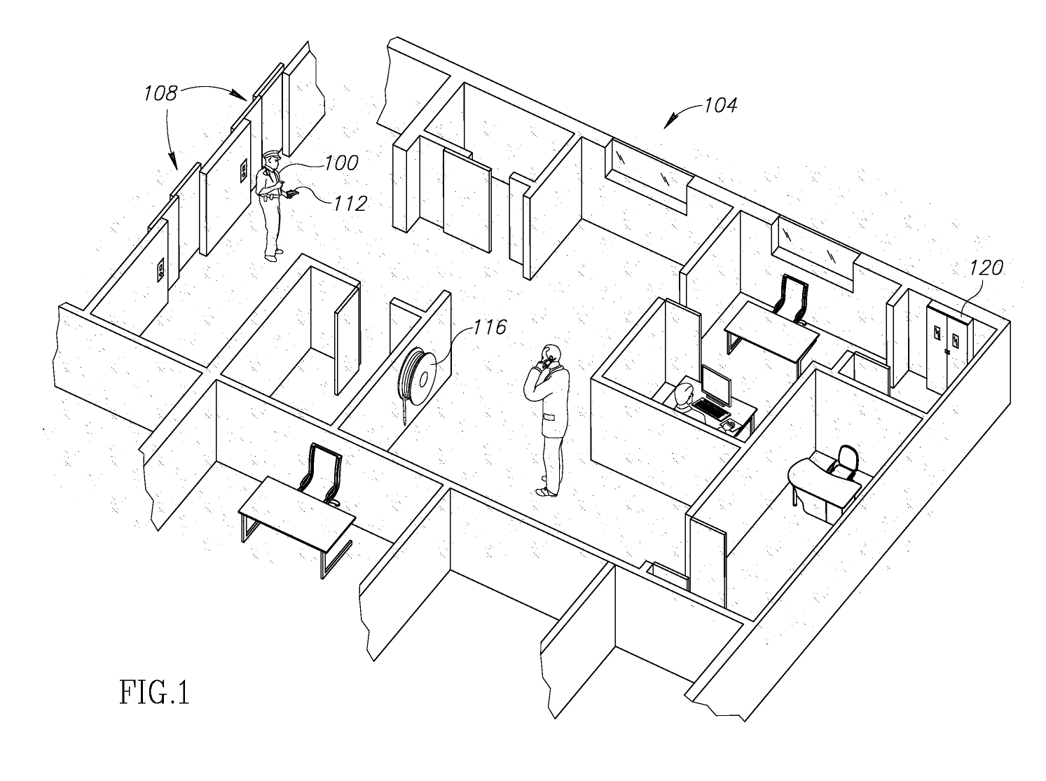

Referring now to FIG. 1, showing a schematic exemplary illustration of a user carrying and using a navigation device in accordance with the disclosure. User 100, such as a policeman or a fire fighter is entering a floor or a part thereof 104 within a building, which is covered with smoke, so that visibility is limited.

User 100 is at the entry to floor 104, as can be seen by elevator doors 108 behind user 100. User 100 is supposed to reach fire hydrant 116 and fuse box 120. However, fire hydrant 116 and fuse box 120 are invisible from the entry to floor 104, let alone under smoke conditions.

For navigating to fire hydrant 116 and to fuse box 120, user 100 is holding and using a navigation device 112. Navigation device 112 has stored thereon the absolute coordinates of the entry point to the floor, and also of fire hydrant 116 and fuse box 120. User 100 indicates to device 112 that he is at the entry point, and the object he first wishes to navigate to, such as fire hydrant 116. Device 112 calculates the distance and direction the user has to take, and presents them to user 100, for example on a map, in a textual manner, vocally, or the like, using an output device of device 12, such as a graphic display. When user 100 advances, the device determines the distance the user walked, for example by the number of steps he took which may be obtained from a pedometer embedded within the device. The device further determines the direction the user walked in, using for example a gyroscope embedded into the device. The device may update the current location of the user, for example by integrating the distance and direction, and may update the navigation directions in accordance with user 100 current location. If user 100 reaches and identifies another stationary object for which location information is available, then 100 user may indicate the object to the device, in order to receive updated and accurate instructions.

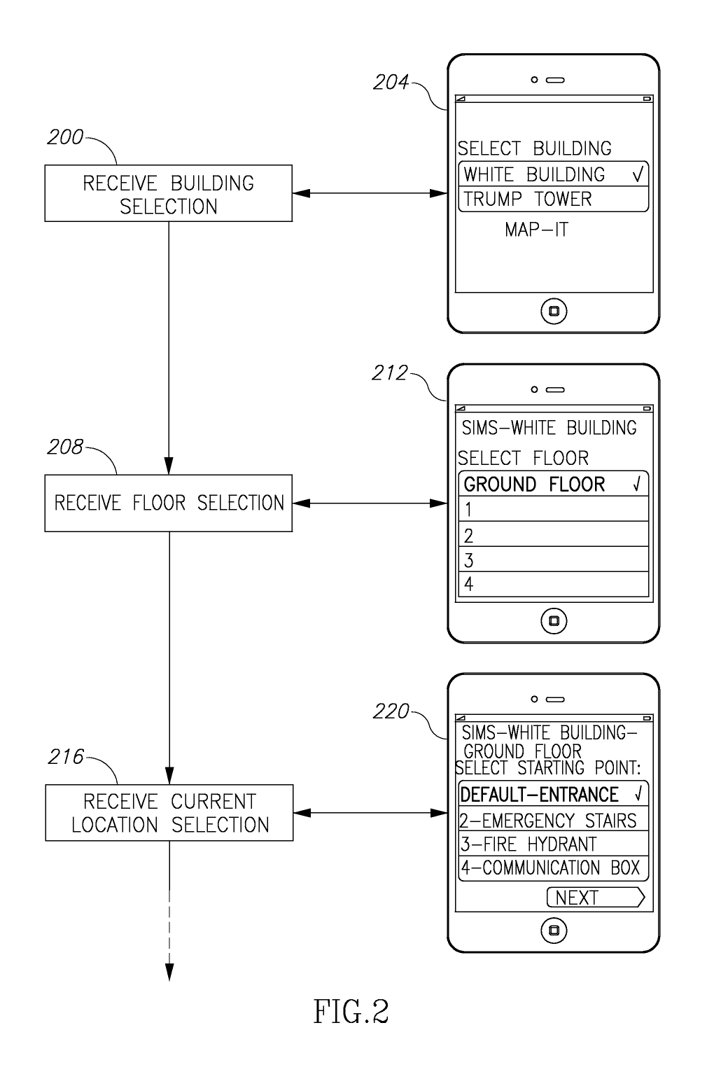

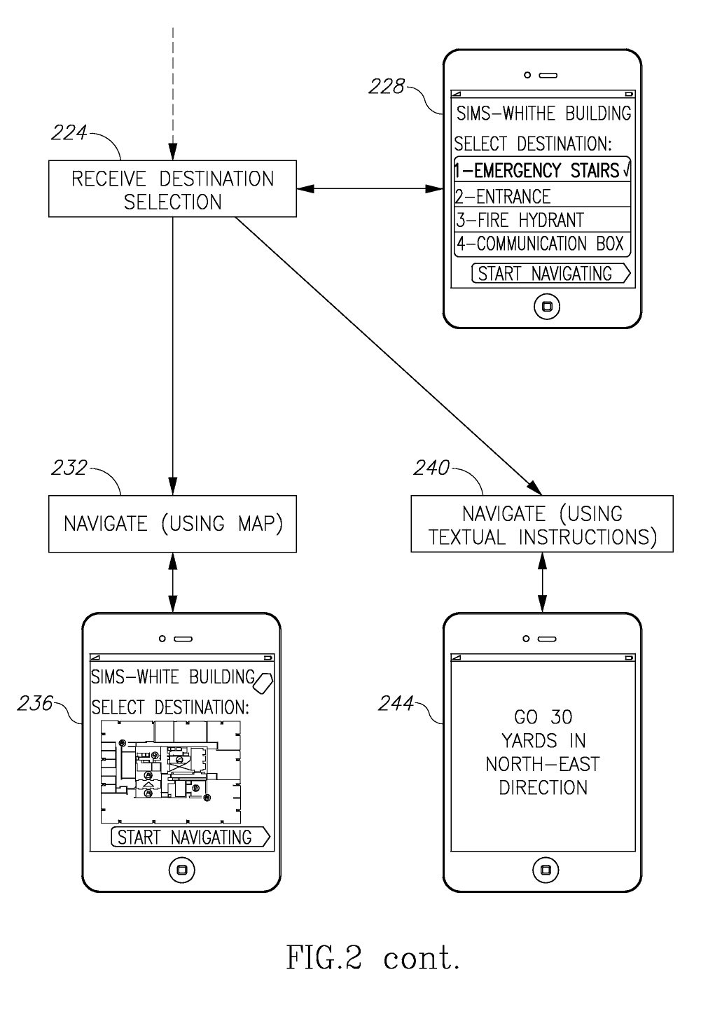

Referring now to FIG. 2, showing an exemplary sequence of steps taken when navigating within a building, using a navigation device such as device 112 of FIG. 1, and the associated screen shots associated with the steps.

On optional step 200 the device may receive a selection from a user, the selection indicating the building the user is entering. Screenshot 204 shows the possibilities the user can select from, and the user's selection of the “White Building”.

On optional step 208 the device may receive a selection from the user indicating the floor of the building the user is entering. Screenshot 212 shows the possibilities the user can select from, and his selection of the ground floor.

On step 216 the device receives a selection from the user indicating the user's current location. Screenshot 220 shows the possibilities the user can select from, and his selection of the entrance, which may also be the default.

On step 224 the device may receive a destination selection from the user indicating where the user wishes to navigate to. Screenshot 228 shows the possibilities the user can select from, and his selection of the emergency stairs. Then, after receiving the user's press on the “start navigating” button, the device may provide the user with navigation instructions, which may be provided visually on a map, textually, or in any other manner. The instruction delivery method may be predetermined, configurable, selected by the user, or the like.

If the instructions are to be provided on a map then on step 232 the device presents to the user map 236 with indications of the user's destination, estimated current location and optionally additional information, such as the last stationary object the user reported, additional objects, or the like.

If the instructions are to be provided textually then on step 240 the device presents to the user instructions 244 which include the distance and direction the user has to take.

In both screens 236 and 240, an arrow pointing at a predetermined direction such as the north, and/or an arrow indicating the direction the user is walking in or should be taking, may be presented.

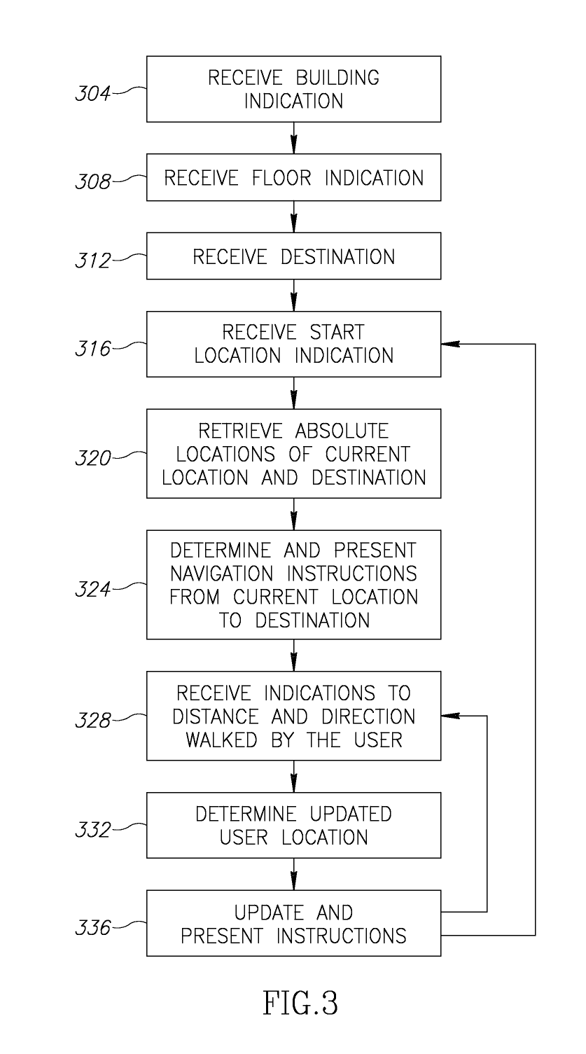

Referring now to FIG. 3 showing a flowchart of steps in a method for navigating within a building.

On optional step 304 an indication to the building the user has to navigate within may be received. The building may be selected from a list, typed, or the like.

On optional step 308 the floor the user has to navigate within may be received, for example by selecting from a list or entering a number.

On step 312 the destination location of the user may be received, the destination location may be selected from a list of locations, which may be associated with stationary objects, for which the absolute coordinates are known. The start and destination locations are selected from available locations in the same building.

On step 316 the start location of the user may be received, the start location may be selected from a list of locations, which may be associated with stationary objects, for which the absolute coordinates are known.

It will be appreciated that steps 312 and 316 can be performed in reverse order.

On step 320 the absolute locations, for example in world coordinates of the user's current location and the destination location.

On step 324, instructions are determined for navigating from the start location to the destination location. The instructions may include the distance and direction to walk. The instructions do not take into account internal walls separating between the start location and the destination, so that a user may take the general direction and correct while walking The instructions are presented to the user on the same device with which he or she made their selections. The instructions may be presented in the form of a map showing the current location and the destination, or in textual manner. An arrow indicating a predetermined direction such as the north and/or an arrow indicating the direction the user should take may be presented as well.

On step 328 the device may receive indications to direction or distance walked by the user. The direction indications may be received, for example, from a compass and/or gyroscopic device, and the distance may be received from a pedometer device. The indications may be received as an accumulated distance or direction, or as a series of updates which may be integrated into a total distance and direction. If the user climbed or descended to another floor, this can be determined using an altimeter and optionally information related to the ceiling height of each floor within the building.

On step 332 the user's current location may be updated based on the user's starting point and the received indications. Alternatively, the user's current location may be updated based on a previous updated location and received indications, rather than on the user's starting point.

On step 336, based upon the user's current location, the navigation instructions may be updated and presented to the user on the device.

It will be appreciated that step 328 and 332 may be repeated until the user has reached the destination, or until the user reports that he or she reached another stationary object, which may now be considered to be the start location, at which stage execution may return to step 316. However, the destination absolute coordinates may be reused and do not have to be retrieved again, as long as the destination has not changed.

In some embodiments, the device may sense the number of steps climbed by the user when the user indicated he is near a staircase, and may update the floor and associated stationary objects accordingly, without the user having to select a different floor. Alternatively, the new floor can also be detected using an altimeter providing indications. The stationary objects of the new floor can then be loaded to the device for the user to select from.

In some embodiments, a preliminary step may be performed of calibrating the device to estimate the specific user's step length, in order to determine more accurately the distance passed by the user during navigation.

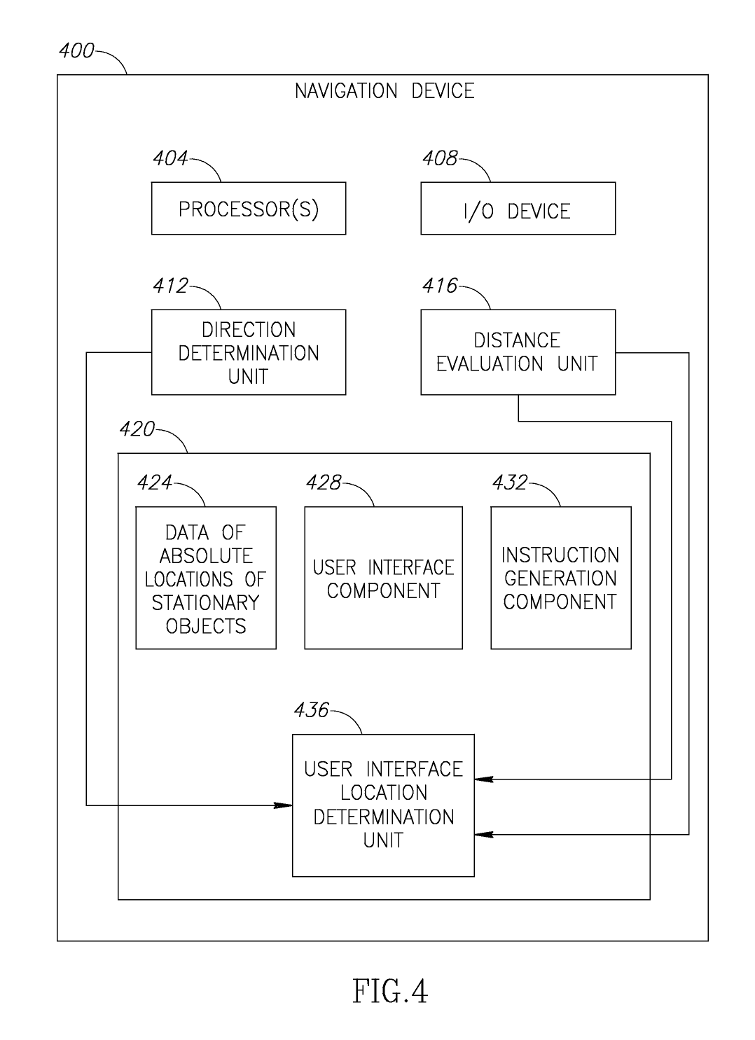

Referring now to FIG. 4, showing a schematic block diagram of a navigation device for navigating within a building towards a stationary object.

Navigation device 400 may comprise one or more processors 404, wherein any of processors 404 may be a Central Processing Unit (CPU), a microprocessor, an electronic circuit, an Integrated Circuit (IC) or the like. Alternatively, navigation device 400 can be implemented as firmware written for or ported to a specific processor such as digital signal processor (DSP) or microcontrollers, or can be implemented as hardware or configurable hardware such as field programmable gate array (FPGA) or application specific integrated circuit (ASIC). Processors 404 may be utilized to perform computations required by navigation device 400 or any of it subcomponents.

In some exemplary embodiments of the disclosed subject matter, navigation device 400 may comprise an input-output (I/O) device 408 such as a display, a keyboard, or another input device to interact with the system, to invoke the system, to provide selections and to receive results. In some embodiments, navigation device 400 may comprise a touch display for a user to easily introduce selections to the device, and for displaying visual and/or textual navigation instructions to a user.

Navigation device 400 may comprise a direction determination unit 412, which may include, for example a compass and/or one or more gyroscopes, and a distance evaluation unit 416 such as a pedometer. Direction determination unit 412 together with distance evaluation unit 416 enable the device to track the distance and direction the user advanced in.

Navigation device 400 may comprise or be in communication with one or more storage devices 420 for storing data and executable components, and which may also contain data obtained during execution of one or more components. Storage device 420 may be persistent or volatile. For example, storage device 420 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, storage device 420 may retain program code operative to cause any of processors 404 to perform acts associated with any of the steps shown in FIG. 3 above, for example determining navigation instructions.

Storage device 420 may store data 424 related to absolute locations of stationary objects, and optionally additional data such as description information. Data 424 may be stored in any required manner, such as a relational database, a hierarchical database, a geographic database, a file arrangement, or the like.

The components detailed below may be implemented as one or more sets of interrelated computer instructions, loaded to storage device 420 and executed for example by any of processors 404 or by another processor. The components may be arranged as one or more executable files, dynamic libraries, static libraries, methods, functions, services, or the like, programmed in any programming language and under any computing environment.

In some embodiments the components loaded to storage device 420 may include a user interface component 428 utilized to receive input such as selections from a user, or to provide output such as navigation instruction to a user.

A further component loaded to storage device 420 is instruction generation component 432, which receives a source location such as a current location of a user and a target location such as the location of a stationary object the user has indicated as a destination. Instruction generation component 432 may retrieve the absolute locations of the source and target, and may determine the distance and direction to be taken in order to reach from the source to the destination, based on their relative locations.

Yet another component loaded to storage device 420 is user updated location determination component 436, for receiving and integrating measures or indications received from direction determination unit 412 and distance evaluation unit 416, and for determining the current location of the user, which can be used for generating updated navigation instructions.

Storage device 420 may also comprise an optional calibration component for determining the length of a specific user's step for better estimating the distance a user walked according to the number of steps counted by the pedometer.

Device 400 can further comprise an altimeter for determining the height the device is at, so that the information related to the stationary object at the relevant floor can be loaded for the user to select from.

The disclosed method and device enable a user to navigate within a building towards one or more predetermined locations, such as locations of stationary objects. The device and method make use of absolute world coordinates in order to determine distance between a start location and a destination. However, the device and method are standalone and do not rely on external systems, such as GPS system to generate the instructions and follow the user's advancement towards the destination.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation, material, step or component to the teachings without departing from the essential scope thereof Therefore, it is intended that the disclosed subject matter not be limited to the particular embodiment disclosed as the best mode contemplated for carrying out this invention, but only by the claims that follow.

In the description and claims of the application, each of the words “comprise” “include” and “have”, and forms thereof, are not necessarily limited to members in a list with which the words may be associated.

What is claimed is:

1. A device for assisting a user to navigate to a stationary object within a building, comprising:
a user interface module for receiving an indication of a current location of a user and of a stationary object within a building, and for presenting navigation instructions to the user;
a storage device for storing absolute locations of the current location and the stationary object;
an instruction generation component for determining distance and navigation instructions between the current location and the stationary object;
a direction determination unit for determining a direction a user holding the device is moving at;
a distance evaluation unit for determining a distance passed by a user holding the device; and
a user updated location determination component for evaluating a current location of a user holding the device, based on information received from the direction determination unit and distance evaluation unit.

2. The device of claim 1 wherein the direction determination component comprises a compass.

3. The device of claim 1 wherein the direction determination component comprises a gyroscope.

4. The device of claim 1 wherein the distance evaluation component is a pedometer.

5. The device of claim 1 further comprising an altimeter for determining the height at which the device is located.

6. A method for assisting a user to navigate to a stationary object within a building, comprising:
receiving a destination indication of a stationary object within a building;
receiving a start location indication within the building;
retrieving absolute location of the current location and the stationary object;
determining navigation instructions between the current location and the stationary object; and
presenting the navigation instructions to the user.

7. The method of claim 6 further comprising:
receiving at least one indication to distance or direction walked by the user;
determining an updated location of the user based on the at least one indication; and
updating the navigation instructions based on the updated location.

8. The method of claim 6 further comprising a calibration step for associating a user's step with a length.

9. The method of claim 6 further comprising:
receiving an indication to a height; and
loading information related to stationary objects located at the height.
